(19) United States
(12) Patent Application Publication
(10) Pub. No.: US 2010/0166446 A1
(43) Pub. Date: Jul. 1, 2010

(54) IMAGE FORMING APPARATUS

(75) Inventors: Hiroyuki NAGANAWA, Kasugai-shi (JP); Hiroyuki TSUJIHARA, Nagoya-shi (JP); Hiroaki NIWA, Nagoya-shi (JP); Shiro UENO, Nagoya-shi (JP)

Correspondence Address: Scully, Scott, Murphy & Presser, P.C., 400 Garden City Plaza, Suite 300, Garden City, NY, 11530, US

(73) Assignee: BROTHER KOGYO KABUSHIKI KAISHA, Aichi-ken (JP)

(21) Appl. No.: 12/646,231

(22) Filed: Dec. 23, 2009

(30) Foreign Application Priority Data
Dec. 26, 2008 (JP) 2008-333820

(51) Int. Cl. G03G 15/20

(52) U.S. Cl. 399/69

(57) ABSTRACT

An image forming apparatus is provided. The image forming apparatus includes an image forming unit; a fuser having a heating unit to which an alternating voltage is applied from an alternating power supply so as to perform heating; a zero-cross pulse generating unit that generates a zero-cross pulse; a voltage estimating unit that estimates the alternating voltage on the basis of a width of the zero-cross pulse; a temperature detecting unit that detects the temperature of the fuser; a heating control parameter setting unit that sets a heating control parameter for controlling the heating unit on the basis of the alternating voltage estimated by the voltage estimating unit and the temperature of the fuser; and a heating control unit that controls the heating unit on the basis of the heating control parameter set by the heating control parameter setting unit.

### CROSS REFERENCE TO RELATED APPLICATION

The present application claims priority from Japanese Patent Application No. 2008-333820, which was filed on Dec. 26, 2008, the disclosure of which is herein incorporated by reference in its entirety.

### TECHNICAL FIELD

Apparatuses and devices consistent with the present invention relate to an image forming apparatus having an image forming unit for forming an image on a printing medium and a fuser that thermally fixes the image formed on the printing medium by the image forming unit, and more particularly, to an image forming apparatus in which the fuser has a heating unit to which an alternating voltage is applied to perform heating.

### BACKGROUND

In a related art image forming apparatus, an image is formed by an image forming unit on a printing medium such as paper by various methods for attaching toner by, for example, electro-photography, and a fuser thermally fixes the image by melting the toner. When the fuser comprises a heating unit such as a halogen heater that performs heating by applying an alternating voltage, it is conceivable that so-called zero-cross points where an absolute value of the alternating voltage is 0 are detected and the zero-cross points are applied to control the heating unit.

In the case of detecting the zero-cross points to apply the zero-cross point to control the heating unit, when an interval between the zero-cross points is less than a predetermined value, the case is determined as an abnormality caused by power supply noise. When such power supply noise frequently occurs, the case is determined as a circumstance with a lot of power supply noise. Such a method has been proposed.

### SUMMARY

In the above disclosure, the alternating voltage is not estimated, and it is difficult to perform control according to fluctuation of the alternating voltage. When a circuit for measuring the alternating voltage is specially provided, it is possible to perform control according to the fluctuation of the alternating voltage. However, in this case, manufacturing costs of the device increase. The invention has been made to provide an image forming apparatus capable of performing control according to fluctuation of the alternating voltage without specially providing a circuit for measuring the alternating voltage.

According to an illustrative aspect of the present invention, there is provided an image forming apparatus comprising: an image forming unit that forms an image on a printing medium; a fuser that has a heating unit to which an alternating voltage is applied from an alternating power supply so as to perform heating, the fuser thermally fixing the image that is formed on the printing medium by the image forming unit; a zero-cross pulse generating unit that generates a zero-cross pulse in accordance with a period when an absolute value of the alternating voltage is less than a predetermined value; a voltage estimating unit that estimates the alternating voltage on the basis of a width of the zero-cross pulse generated by the zero-cross pulse generating unit; a temperature detecting unit that detects the temperature of the fuser; a heating control parameter setting unit that sets a heating control parameter for controlling the heating unit on the basis of the alternating voltage estimated by the voltage estimating unit and the temperature of the fuser detected by the temperature detecting unit; and a heating control unit that controls the heating unit on the basis of the heating control parameter set by the heating control parameter setting unit.

Further, according to another illustrative aspect of the present invention, there is provided an image forming apparatus comprising: an image forming unit that forms an image on a printing medium; a fuser that has a heating unit to which an alternating voltage is applied from an alternating power supply so as to perform heating, the fuser thermally fixing the image that is formed on the printing medium by the image forming unit; a zero-cross pulse generating unit that generates a zero-cross pulse in accordance with a period when an absolute value of the alternating voltage is less than a predetermined value; a voltage estimating unit that estimates the alternating voltage on the basis of a width of the zero-cross pulse generated by the zero-cross pulse generating unit; a temperature detecting unit that detects the temperature of the fuser; an operation control unit that controls the heating unit until the temperature detected by the temperature detecting unit reaches a regulation temperature by applying the alternating voltage from the alternating power supply to the heating unit when the image forming apparatus is activated; a time-out time setting unit that sets a time-out time related to the control of the operation control unit on the basis of the alternating voltage estimated by the voltage estimating unit; and a fixation abnormality determining unit that determines abnormalities in the fuser when the temperature detected by the temperature detecting unit does not reach the regulation temperature after the operation control unit starts the control of the heating unit and the time-out time set by the time-out time setting unit has elapsed.

### BRIEF DESCRIPTION OF THE DRAWINGS

Illustrative aspects of the invention will be described in detail with reference to the following figures wherein:

FIG. 1 is a diagram schematically illustrating a configuration of a laser printer according to an exemplary embodiment;

FIG. 2 is a circuit diagram illustrating a configuration for controlling a heater of the laser printer;

FIG. 3 is a flowchart illustrating a warm-up process performed by the circuit; and

FIG. 4 is a flowchart illustrating a printing process performed by the circuit.

### DETAILED DESCRIPTION OF EXEMPLARY EMBODIMENTS OF THE PRESENT INVENTION

### Configuration of Laser Printer

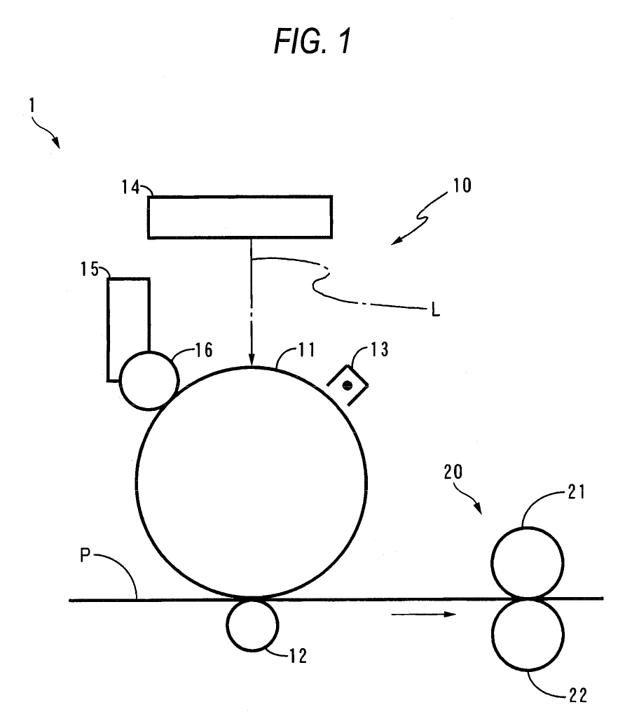

Hereinafter, an exemplary embodiment of the invention will be described with reference to the drawings. FIG. 1 is a diagram schematically illustrating a configuration of a laser printer 1 as an image forming apparatus. As shown in FIG. 1, the laser printer 1 according to the exemplary embodiment comprises an image forming unit 10 as an example of an image forming unit for forming an image on a sheet P used as a printing medium by electro-photography.

The image forming unit 10 forms a toner image on the sheet P while the sheet P is transported between a photosensitive drum 11 and a transfer roller 12 in a direction indicated by an arrow. A main body of the photosensitive drum 11 is connected to the ground, and a positive electric photosensitive layer is formed on a surface of the photosensitive drum 11. The photosensitive drum 11 is supported in the laser printer 1 so as to be able to rotate anticlockwise in FIG. 1.

An electric charger 13, a laser scanner unit 14, and a development unit 15 are disposed in order on an outer periphery of the photosensitive drum 11 along the rotation direction of the photosensitive drum 11 from a portion opposed to the transfer roller 12. The electric charger 13 is a scorotron electric charger for positive charging so as to generate corona discharge from a charging wire such as tungsten, and is configured to electrically charge the surface of the photosensitive drum 11 with a uniform positive polarity. The laser scanner unit 14 is a laser scanner unit that emits laser light L, which is based on image data input from the outside, from a light source and scans the laser light L by a mirror surface of a polygon mirror rotated by a polygon motor to irradiate the surface of the photosensitive drum 11 with the laser light L.

The development unit 15 comprises a development roller 16 at a portion opposed to the photosensitive drum 11. The development unit 15 supplies positive electric nonmagnetic 1-component polymer toner accommodated in the development unit 15 to the surface of the photosensitive drum 11 through the development roller 16 while rubbing and charging it by a supply roller, a layer restriction blade, and the like.

According to the above configuration, first, the surface of the photosensitive drum 11 is uniformly positively charged by the electric charger 13 with the rotation of the photosensitive drum 11, and then is exposed to light by high-speed scanning of the laser light L from the laser scanner unit 14, thereby forming an electrostatic latent image based on the image data.

When the positively charged toner is supplied from the development unit 15 to the photosensitive drum 11, the toner is supplied to the electrostatic latent image formed on the surface of the photosensitive drum 11, that is, the exposed part, which is exposed by the laser light L, with lowered electric potential on the surface of the photosensitive drum 11 which is uniformly positively charged. The toner is selectively supported to be a visible image, thereby forming a toner image.

The transfer roller 12 is supported in the laser printer 1 so as to be able to rotate clockwise in FIG. 1. The transfer roller 12 is formed by covering a metal roller shaft with a roller made of ion-conductive rubber, and transfer bias (transfer positive bias) is applied to the transfer roller 12 when transferring. According to the above configuration, the toner image supported on the surface of the photosensitive drum 11 is transferred to the sheet P while the sheet P passes between the photosensitive drum 11 and the transfer roller 12. The sheet P after the transfer of the toner image is transported to a fuser 20 having a heating roller 21 and a pressing roller 22, and the toner image is thermally fixed.

### (Circuit Configuration for Controlling Heater)

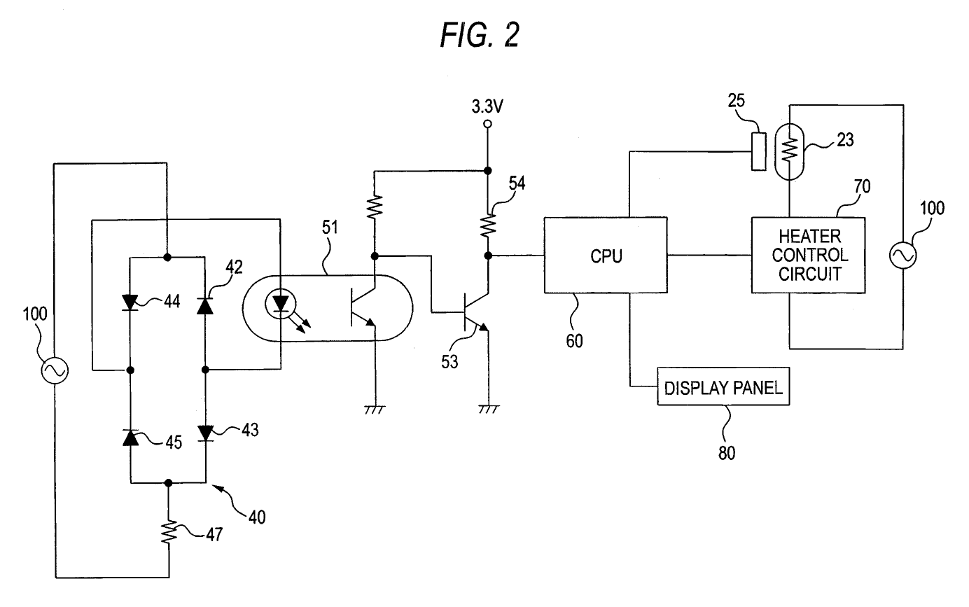

The fuser 20 comprises a halogen heater 23 as an example of a heating unit for heating the surface of the heating roller 21, and a thermistor 25 as an example of a temperature detecting unit for detecting the surface temperature of the heating roller 21 (see FIG. 2). Next, a circuit configuration for controlling the halogen heater 23 will be described with reference to FIG. 2.

As shown in FIG. 2, a commercial power supply 100 as an example of a 100 V alternating power supply connected to the laser printer 1 is connected to a bridge circuit 40 through a resistor 47, the bridge circuit 40 performing full-wave rectification on the alternating voltage applied from the commercial power supply 100 by four diodes 42, 43, 44, and 45. The alternating voltage rectified by the bridge circuit 40 is input to a base of a transistor 53 through a photo isolator 51. When an absolute value of the alternating voltage is lower than a threshold value determined according to characteristics of the diodes 42, 43, 44, and 45, the bridge circuit 40 does not allow electric current to pass. Only when the absolute value of the alternating current is less than the threshold value, base electric current flows in the transistor 53.

A collector of the transistor 53 is connected to direct current power supply of 3.3 V through a resistor 54, and an emitter thereof is connected to the ground. The collector of the transistor 53 is connected to a CPU 60 having a ROM, a RAM, and the like therein. According to the above configuration, while the alternating voltage is less than the threshold value, an L-level signal (hereinafter, referred to as a zero-cross pulse) having a rectangular pulse shape is input from the transistor 53 to the CPU 60. That is, a series of circuits from the bridge circuit 40 to the transistor 53 corresponds to zero-cross pulse generating unit.

The commercial power supply 100 is serially connected to the halogen heater 23, and the CPU 60 is connected to a control circuit 70 for controlling energization to the halogen heater 23, the thermistor 25, and a display panel 80 provided on a surface of a case of the laser printer 1. And, a main switch is provided between the commercial power supply 100 and the bridge circuit 40 and between the commercial power supply 100 and the halogen heater 23.

### Process in the Exemplary Embodiment

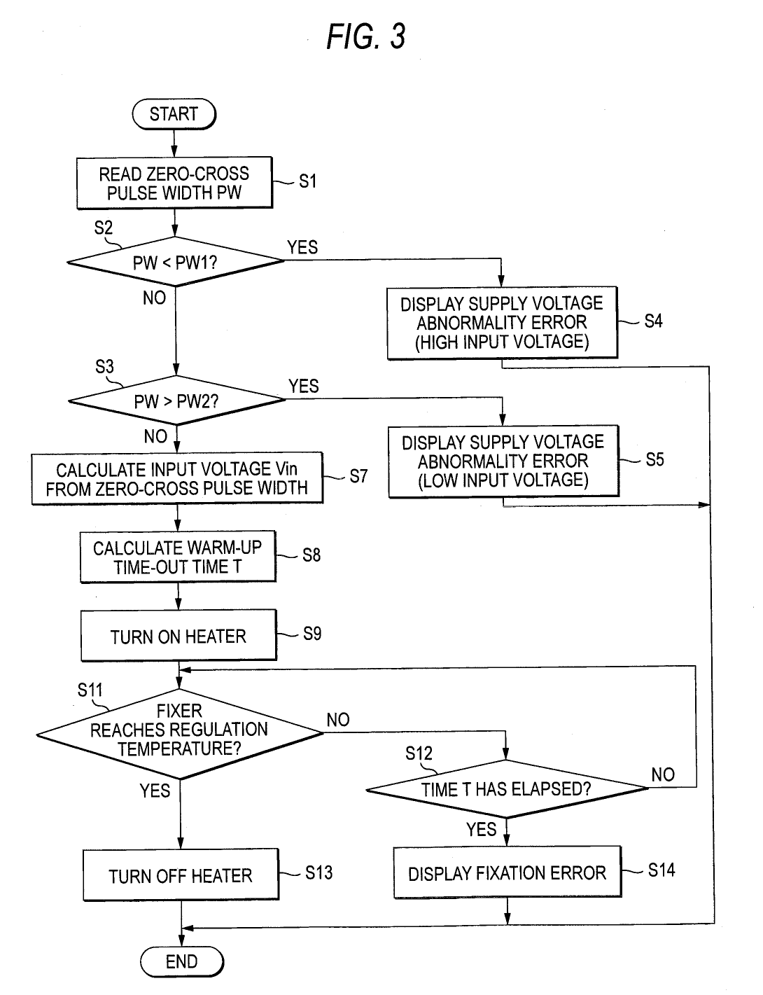

Next, a process performed by the CPU 60 (an example of a power supply abnormality determining unit, a voltage estimating unit, a fixation abnormality determining unit, an operation control unit, a heating control parameter setting unit, a heating control unit, a time-out time setting unit) on the basis of a program stored in the ROM will be described. FIG. 3 is a flowchart illustrating a warm-up process performed when the main switch is turned on. As shown in FIG. 3, in this process, first, in S1 (hereinafter, S indicates a step), the zero-cross pulse width PW is read.

Subsequently, in S2 and S3 as the power supply abnormality determining unit, it is determined whether or not the width PW read in S1 is less than a threshold value PW1 for determining whether the alternating voltage is high (S2), and then it is determined whether or not the width PW is more than a threshold value PW2 for determining whether the alternating voltage is low (S3). That is, the alternating voltage generally represents fluctuation with a substantially sine wave shape. Accordingly, as the alternating voltage gets higher, the zero-cross pulse width PW gets smaller. Thus, in S2 and S3, it is determined whether or not the alternating voltage is within a normal range on the basis of the zero-cross pulse width PW.

In the case of PW<PW1 (S2: Y), a power supply voltage abnormality error representing high input voltage (amplitude of the alternating voltage) is displayed on the display panel 80 in S4. In the case of PW>PW2 (S3: Y), a power supply voltage abnormality error representing low input voltage is displayed on the display panel 80 in S5. Then, the process is ended.

Meanwhile, in the case of PW1≦W≦PW2 (S2: N, S3: N), the process is transferred to S7 as an example of a voltage estimating unit, and an input voltage Vin is calculated on the basis of the zero-cross pulse width PW. Subsequently, in S8, as an example of a time-out time setting unit, a warm-up time-out time T is calculated by the following formula on the basis of the input voltage Vin calculated in S7. In the following formula, Vr denotes rating input voltage, and Tr denotes a warm-up time-out time to be set when inputting rating voltage.

T=(Vr/Vin)*Tr

Subsequently, in S9, the halogen heater 23 is turned on with 100% duty. In S11, it is determined whether or not the surface temperature (hereinafter, referred to as the temperature of the fuser 20) of the heating roller 21 detected by the thermistor 25 reaches a predetermined regulation temperature for warm-up. When the temperature does not reach the regulation temperature (S11: N), the process is transferred to S12 as an example of a fixation abnormality determining unit and it is determined whether or not the warm-up time-out time T has elapsed. When the warm-up time-out time T has not elapsed (S12: N), the process is transferred to S11. When the temperature of the fuser 20 reach the regulation temperature in the course of repeating the processes of 511 and S12 (S11: Y), the halogen heater 23 is turned off in S13 and then the process is ended.

Meanwhile, before the temperature of the fuser 20 reaches the regulation temperature (S11: N), when the warm-up time-out time T has elapsed (S12: Y), a fuser error representing abnormality of the fuser 20 is displayed on the display panel 80 in S14, and the process is ended. In the processes, S9 to S12 correspond to operation control unit.

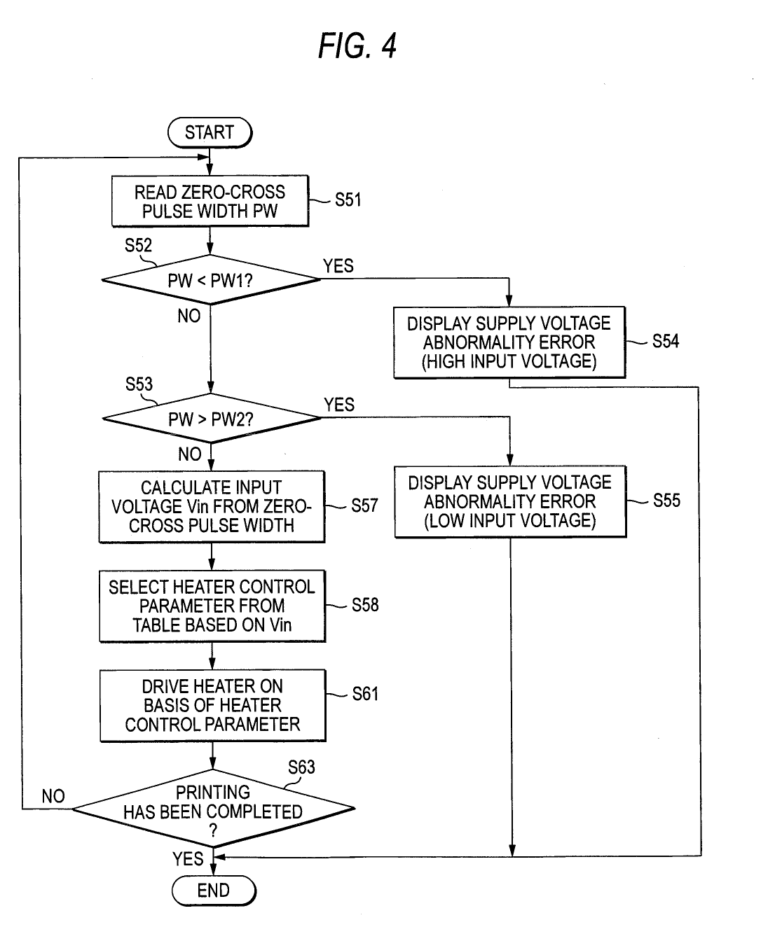

FIG. 4 is a flowchart illustrating a printing process performed when starting an imaging forming process (hereinafter, referred to as printing) by the image forming unit 10 according to an input of image data from the outside. As shown in FIG. 4, in this process, first, in S51 to S57, the same processes as S1 to S7 are performed. That is, the zero-cross pulse width W is read (S51). In the case of PW<PW1 (S52: Y), the power supply voltage abnormality error representing high input voltage is displayed (S54), and the process is ended. In the case of PW>PW2 (S53: Y), the power supply voltage abnormality error representing low input voltage is displayed (S55), and the process is ended.

Meanwhile, in the case of PW1≦W≦PW2 (S52: N, S53: N), the process is transferred to S57 as an example of a voltage estimating unit, and the input voltage Vin is calculated on the basis of the zero-cross pulse width PW. Subsequently, in S58 as an example of a heating control parameter setting unit, a control parameter is selected using a table shown in Table 1 on the basis of the input voltage Vin calculated in S57 and the temperature detected by the thermistor 25.

TABLE 1

| | Input Voltage Range | | |
|---|---|---|---|
| | 80 V to | 90 V to | 100 V to |
| Detection Temp. | 90 V | 100 V | 110 V |
| Target Temp. + T1 or more | OFF | OFF | OFF |
| Target Temp. + T2 to Target Temp. + T1 | Duty1 | OFF | OFF |
| Target Temp. + T3 to Target Temp. + T2 | Duty2 | Duty1 | OFF |
| Target Temp. to Target Temp. + T3 | Duty3 | Duty2 | Duty1 |
| Target Temp. − T4 to Target Temp. | Duty4 | Duty3 | Duty2 |
| Target Temp. − T5 to Target Temp. − T4 | Duty5 | Duty4 | Duty3 |
| Target Temp. − T6 to Target Temp. − T5 | Duty6 | Duty5 | Duty4 |
| Target Temp. − T7 to Target Temp. − T6 | Duty7 | Duty6 | Duty5 |
| Target Temp. − T8 to Target Temp. − T7 | Duty8 | Duty7 | Duty6 |
| Target Temp. − T9 to Target Temp. − T8 | Duty9 | Duty8 | Duty7 |
| Target Temp. − T10 to Target Temp. − T9 | Duty10 | Duty9 | Duty8 |

That is, the control parameter is a parameter for defining what percentage of duty is the halogen heater 23 turned on with, on the basis of what range (input voltage range) is the input voltage Vin in and how much does the detected temperature deviate from a target temperature. In Table 1, predetermined values are set as T1 to T10 or Duty1 to Duty10. In Table 1, a condition for turning off the halogen heater 23 is prescribed.

Subsequently, in S61 as an example of a heating control unit, the halogen heater 23 is driven (or turned off) on the basis of the control parameter. In S63, it is determined whether or not the printing has been completed. When the printing has not been completed (S63: N), the process is transferred to S51 and the above-described processes are repeated. When the printing has been completed (S63: Y), the process is ended.

### Advantage and Modified Example of Embodiment

As described above, according to the exemplary embodiment, the input voltage Vin is calculated on the basis of the zero-cross pulse width PW, and the warm-up time T and the heater control parameter are set on the basis of the input voltage Vin. Accordingly, it is possible to perform control according to the fluctuation of the alternating voltage without specially providing a circuit for measuring the alternating voltage. In addition, according to the exemplary embodiment, when the zero-cross pulse width PW is not within the predetermine range of PW1≦PW≦PW2, the abnormality of the power supply voltage is reported to prevent the halogen heater 23 from being turned on in S9 or S61. Accordingly, it is possible to reduce the chance of a fixation error.

In addition, the invention is not limited to the above described exemplary embodiment, and may be embodied in various types within the scope of the invention. For example, the control type of the fuser 20 using the input voltage Vin calculated from the zero-cross pulse width PW may be variously modified. The calculated input voltage Vin may be applied to the other control.

In the exemplary embodiment, the input voltage Vin from the commercial power supply 100 is calculated. However, when alternating voltage is applied to the heating unit by a power supply circuit having a transformer provided in the image forming apparatus, the input voltage may be calculated from the power supply circuit. The fuser of the invention is not limited to having the heating roller 21 and the pressing roller 22, and various types of fusers may be applied, for example, a fuser having a platen shape on one side.

According to a first illustrative aspect of the present invention, there is provided an image forming apparatus comprising: an image forming unit that forms an image on a printing medium; a fuser that has a heating unit to which an alternating voltage is applied from an alternating power supply so as to perform heating, the fuser thermally fixing the image that is formed on the printing medium by the image forming unit; a zero-cross pulse generating unit that generates a zero-cross pulse in accordance with a period when an absolute value of the alternating voltage is less than a predetermined value; a voltage estimating unit that estimates the alternating voltage on the basis of a width of the zero-cross pulse generated by the zero-cross pulse generating unit; a temperature detecting unit that detects the temperature of the fuser; a heating control parameter setting unit that sets a heating control parameter for controlling the heating unit on the basis of the alternating voltage estimated by the voltage estimating unit and the temperature of the fuser detected by the temperature detecting unit; and a heating control unit that controls the heating unit on the basis of the heating control parameter set by the heating control parameter setting unit.

According to the first illustrative aspect of the present invention, the zero-cross pulse generating unit generates a zero-cross pulse according to a period when an absolute value of the alternating voltage is less than a predetermined value (e.g., a threshold value determined according to a circuit configuration of the unit). The alternating voltage generally represents fluctuation with a substantially sine wave shape when disregarding the power supply noise or the like. Accordingly, a width of the zero-cross pulse changes with the amplitude of the alternating voltage. Thus, the voltage estimating unit estimates the alternating voltage on the basis of the width of the zero-cross pulse generated by the zero-cross pulse generating unit.

Then, the heating control parameter setting unit sets a heating control parameter for controlling the heating unit on the basis of the alternating voltage estimated by the voltage estimating unit and the temperature of the fuser detected by the temperature detecting unit. Accordingly, the heating control unit controls the heating unit on the basis of the set heating control parameter.

As described above, the alternating voltage is estimated on the basis of the width of the zero-cross pulse, and the heating control parameter is set on the basis of the voltage. Therefore, it is possible to perform control according to the fluctuation of the alternating voltage without specially providing a circuit for measuring the alternating voltage. In the first illustrative aspect of the present invention, the alternating power supply may be provided outside the image forming apparatus or inside the image forming apparatus.

According to a second illustrative aspect of the present invention, there is provided an image forming apparatus comprising: an image forming unit that forms an image on a printing medium; a fuser that has a heating unit to which an alternating voltage is applied from an alternating power supply so as to perform heating, the fuser thermally fixing the image that is formed on the printing medium by the image forming unit; a zero-cross pulse generating unit that generates a zero-cross pulse in accordance with a period when an absolute value of the alternating voltage is less than a predetermined value; a voltage estimating unit that estimates the alternating voltage on the basis of a width of the zero-cross pulse generated by the zero-cross pulse generating unit; a temperature detecting unit that detects the temperature of the fuser; an operation control unit that controls the heating unit until the temperature detected by the temperature detecting unit reaches a regulation temperature by applying the alternating voltage from the alternating power supply to the heating unit when the image forming apparatus is activated; a time-out time setting unit that sets a time-out time related to the control of the operation control unit on the basis of the alternating voltage estimated by the voltage estimating unit; and a fixation abnormality determining unit that determines abnormalities in the fuser when the temperature detected by the temperature detecting unit does not reach the regulation temperature after the operation control unit starts the control of the heating unit and the time-out time set by the time-out time setting unit has elapsed.

According to the second illustrative aspect of the present invention, similarly to the first illustrative aspect of the present invention, the voltage estimating unit estimates the alternating voltage on the basis of the width of the zero-cross pulse generated by the zero-cross pulse generating unit. Meanwhile, in the second illustrative aspect of the present invention, the operation control unit controls the heating unit, until the temperature detected by the temperature detecting unit becomes the regulation temperature by applying the alternating voltage from the alternating power supply to the heating unit when the image forming apparatus is activated. In the second illustrative aspect of the present invention, the time-out time setting unit sets the time-out time related to control of the operation control unit on the basis of the alternating voltage estimated by the voltage estimating unit. Even when the time-out time elapses after the operation control unit starts the control, the temperature detected by the temperature detecting unit may not reach the regulation temperature. In this case, the fixation abnormality determining unit determines an abnormality in the fuser.

As described above, the alternating voltage is estimated on the basis of the width of the zero-cross pulse, and the time-out time is set on the basis of the voltage. Therefore, it is possible to perform control according to the fluctuation of the alternating voltage without specially providing a circuit for measuring the alternating voltage. In the second illustrative aspect of the present invention, the alternating power supply may be provided outside the image forming apparatus or inside the image forming apparatus.

The invention is not limited to the following configuration. For example, the image forming apparatus described above may further comprises a power supply abnormality determining unit that determines abnormality of the alternating power supply when the width of the zero-cross pulse generated by the zero-cross pulse generating unit is not within a predetermined range. In this case, when the width of the zero-cross pulse is not within the predetermined range, the power supply abnormality determining unit can determines an abnormality in the alternating voltage (e.g., the alternating voltage is too high or low). Accordingly, it is possible to perform control in response to the abnormality.

What is claimed is:

1. An image forming apparatus comprising:
an image forming unit that forms an image on a printing medium;
a fuser that has a heating unit to which an alternating voltage is applied from an alternating power supply so as to perform heating, the fuser thermally fixing the image that is formed on the printing medium by the image forming unit;
a zero-cross pulse generating unit that generates a zero-cross pulse in accordance with a period when an absolute value of the alternating voltage is less than a predetermined value;
a voltage estimating unit that estimates the alternating voltage on the basis of a width of the zero-cross pulse generated by the zero-cross pulse generating unit;
a temperature detecting unit that detects the temperature of the fuser;
a heating control parameter setting unit that sets a heating control parameter for controlling the heating unit on the basis of the alternating voltage estimated by the voltage estimating unit and the temperature of the fuser detected by the temperature detecting unit; and
a heating control unit that controls the heating unit on the basis of the heating control parameter set by the heating control parameter setting unit.

2. An image forming apparatus comprising:
an image forming unit that forms an image on a printing medium;
a fuser that has a heating unit to which an alternating voltage is applied from an alternating power supply so as to perform heating, the fuser thermally fixing the image that is formed on the printing medium by the image forming unit;
a zero-cross pulse generating unit that generates a zero-cross pulse in accordance with a period when an absolute value of the alternating voltage is less than a predetermined value;
a voltage estimating unit that estimates the alternating voltage on the basis of a width of the zero-cross pulse generated by the zero-cross pulse generating unit;
a temperature detecting unit that detects the temperature of the fuser;
an operation control unit that controls the heating unit until the temperature detected by the temperature detecting unit reaches a regulation temperature by applying the alternating voltage from the alternating power supply to the heating unit when the image forming apparatus is activated;
a time-out time setting unit that sets a time-out time related to the control of the operation control unit on the basis of the alternating voltage estimated by the voltage estimating unit; and
a fixation abnormality determining unit that determines abnormalities in the fuser when the temperature detected by the temperature detecting unit does not reach the regulation temperature after the operation control unit starts the control of the heating unit and the time-out time set by the time-out time setting unit has elapsed.

3. The image forming apparatus according to claim 1, further comprising a power supply abnormality determining unit that determines abnormalities in the alternating power supply when the width of the zero-cross pulse generated by the zero-cross pulse generating unit is not within a predetermined range.

4. The image forming apparatus according to claim 2, further comprising a power supply abnormality determining unit that determines abnormalities in the alternating power supply when the width of the zero-cross pulse generated by the zero-cross pulse generating unit is not within a predetermined range.
